(19) United States
(12) Patent Application Publication
(10) Pub. No.: US 2023/0239794 A1
(43) Pub. Date: Jul. 27, 2023

(54) MULTIPLE WUS INDICATION WITH MULTIPLE DRX GROUPS

(71) Applicant: QUALCOMM Incorporated, San Diego, CA (US)

(72) Inventors: Jingchao BAO, San Diego, CA (US); Sony AKKARAKARAN, Poway, CA (US); Tao LUO, San Diego, CA (US); Alexandros MANOLAKOS, Escondido, CA (US); Juan MONTOJO, San Diego, CA (US)

(21) Appl. No.: 18/008,950

(22) PCT Filed: Apr. 27, 2021
(86) PCT No.: PCT/US2021/029471

§ 371 Date: Dec. 7, 2022

(30) Foreign Application Priority Data
Jul. 9, 2020 (GR) 20200100401

(51) Int. Cl. H04W 52/02

(52) U.S. Cl. CPC H04W 52/0229

(57) ABSTRACT

The present disclosure relates to methods and devices for wireless communication including an apparatus, e.g., a UE and/or a TRP. The apparatus may receive a plurality of DRX configurations associated with a plurality of DRX groups. The apparatus may also monitor for one or more WUSs associated with the plurality of DRX groups based on the plurality of DRX configurations, at least one WUS of the one or more WUSs including one or more WUS indicators for the plurality of DRX groups. The apparatus may also determine whether to wake-up for or to sleep through one or more DRX cycles for the plurality of DRX groups based on the at least one WUS indicator or the one or more WUS indicators. The apparatus may also receive the one or more WUSs including the at least one WUS.

### CROSS REFERENCE TO RELATED APPLICATION(S)

This application claims the benefit of Greek Application No. 20200100401, entitled “METHODS AND APPARATUS FOR MULTIPLE WUS INDICATION WITH MULTIPLE DRX GROUPS” and filed on Jul. 9, 2020, which is expressly incorporated by reference herein in its entirety.

### BACKGROUND

### Technical Field

The present disclosure relates generally to communication systems, and more particularly, to paging in wireless communication systems.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive a plurality of discontinuous reception (DRX) configurations associated with a plurality of DRX groups. The apparatus may also monitor for one or more wake-up signals (WUSs) associated with the plurality of DRX groups based on the plurality of DRX configurations, at least one WUS of the one or more WUSs including one or more WUS indicators for the plurality of DRX groups. Additionally, the apparatus may receive the one or more WUSs including the at least one WUS, where the at least one WUS may be associated with at least two DRX groups of the plurality of DRX groups. The apparatus may also determine whether to wake-up for or to sleep through one or more DRX cycles for the plurality of DRX groups based on the at least one WUS indicator or the one or more WUS indicators.

In another aspect of the disclosure, a method, a computer-readable medium, and an apparatus are provided. The apparatus may be a base station or a transmission-reception point (TRP). The apparatus may transmit a plurality of discontinuous reception (DRX) configurations associated with a plurality of DRX groups. The apparatus may also transmit one or more wake-up signals (WUSs) associated with the plurality of DRX groups based on the plurality of DRX configurations, at least one WUS of the one or more WUSs including one or more WUS indicators for the plurality of DRX groups. Further, the at least one WUS indicator and the one or more WUS indicators may be associated with one or more DRX cycles for the plurality of DRX groups.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram illustrating example DRX communication in accordance with one or more techniques of the present disclosure.

FIG. 5 is a diagram illustrating example DRX communication in accordance with one or more techniques of the present disclosure.

FIG. 6 is a diagram illustrating example communication between a UE and a base station in accordance with one or more techniques of the present disclosure.

FIG. 7 is a flowchart of a method of wireless communication.

FIG. 8 is a flowchart of a method of wireless communication.

FIG. 9 is a diagram illustrating an example of a hardware implementation for an example apparatus.

FIG. 10 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

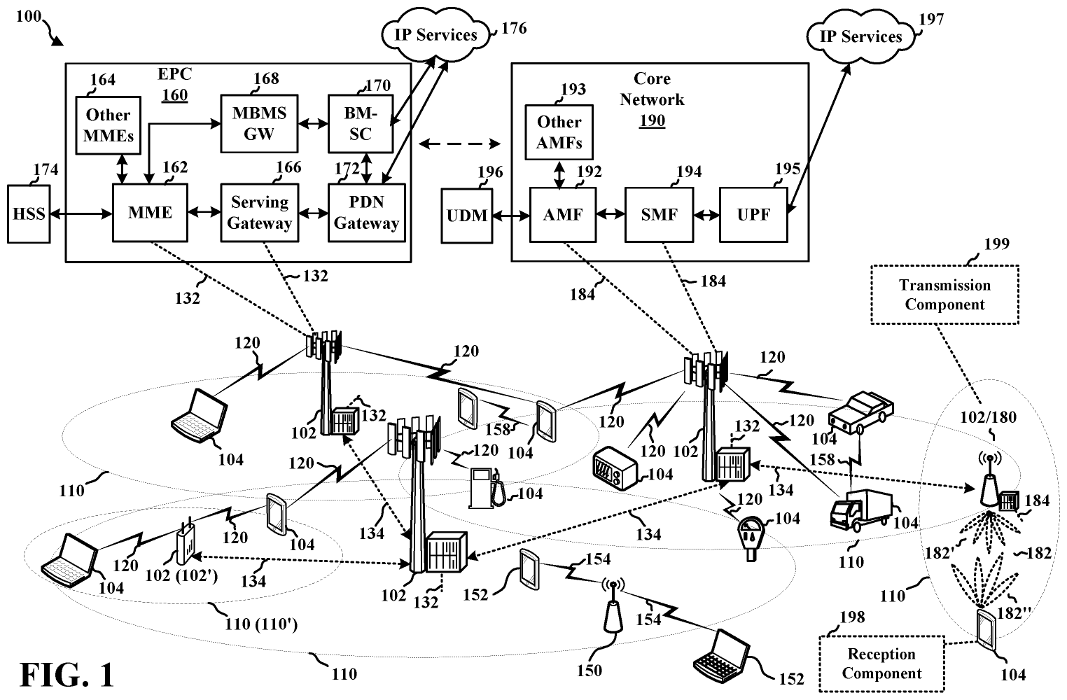

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmission-reception point (TRP), or some other suitable terminology. The base station 102 provides an access point to the EPC 160 or core network 190 for a UE 104. Example s of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a reception component 198 configured to receive a plurality of discontinuous reception (DRX) configurations associated with a plurality of DRX groups. Reception component 198 may also be configured to monitor for one or more wake-up signals (WUSs) associated with the plurality of DRX groups based on the plurality of DRX configurations, at least one WUS of the one or more WUSs including one or more WUS indicators for the plurality of DRX groups. Reception component 198 may also be configured to receive one or more WUSs including the at least one WUS, where the at least one WUS may be associated with at least two DRX groups of the plurality of DRX groups. Reception component 198 may also be configured to determine whether to wake-up for or to sleep through one or more DRX cycles for the plurality of DRX groups based on the at least one WUS indicator or the one or more WUS indicators.

Referring again to FIG. 1, in certain aspects, the base station 180 may include a transmission component 199 configured to transmit one or more discontinuous reception (DRX) configurations associated with a plurality of DRX groups. Transmission component 199 may also be configured to transmit a plurality of wake-up signals (WUSs) associated with the plurality of DRX groups based on the plurality of DRX configurations, at least one WUS of the one or more WUSs including one or more WUS indicators for the plurality of DRX groups. Further, the at least one WUS indicator and the one or more WUS indicators may be associated with one or more DRX cycles for the plurality of DRX groups.

Although the following description may be focused on 5G NR, the concepts described herein may be applicable to other similar areas, such as LTE, LTE-A, CDMA, GSM, and other wireless technologies.

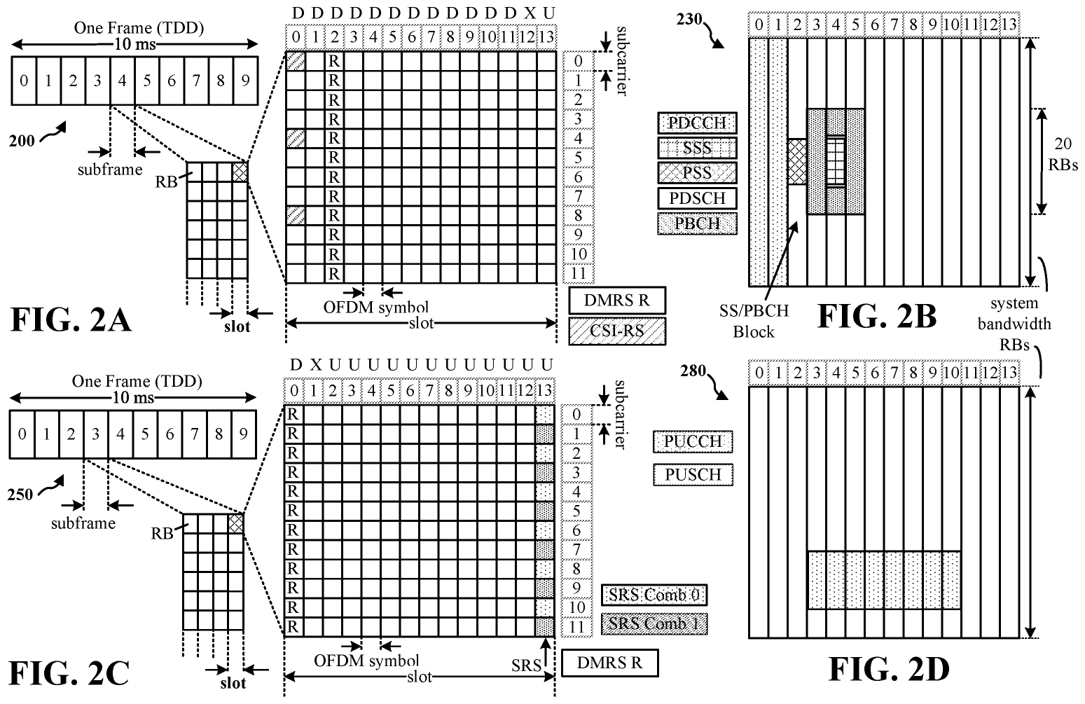

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) ACK/NACK feedback. The PUSCH carries data, and may additionally be used to carry a buffer status report (BSR), a power headroom report (PHR), and/or UCI.

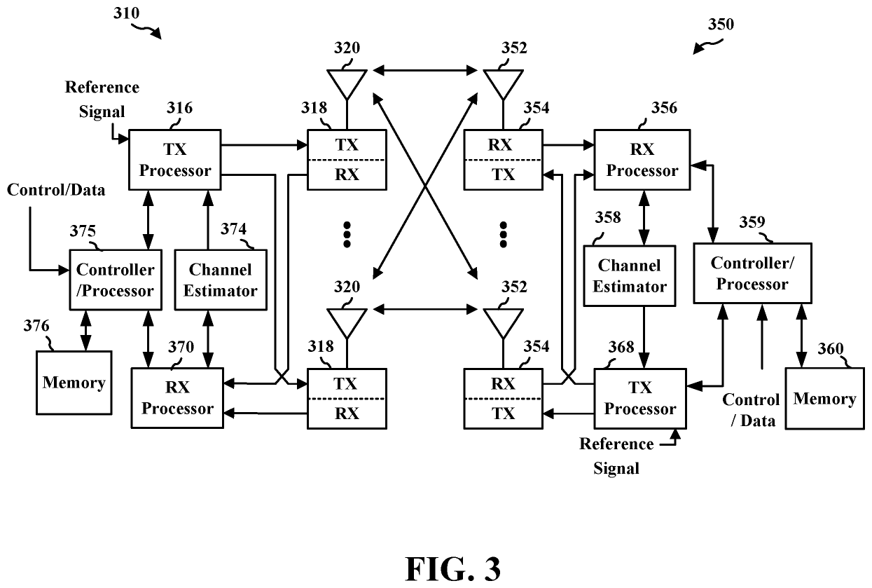

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

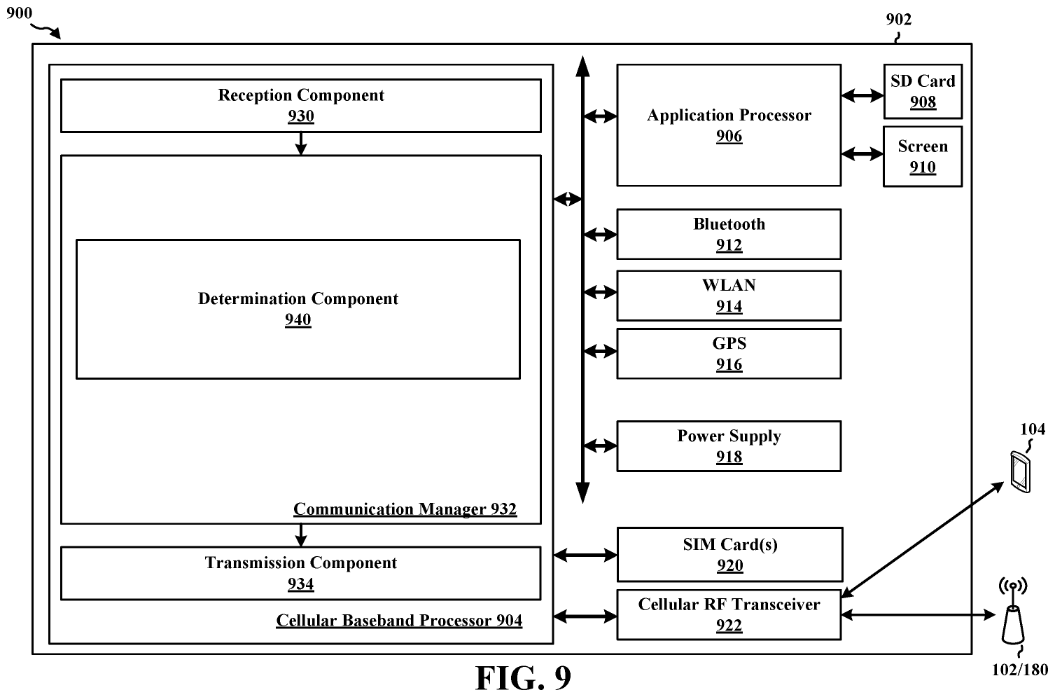

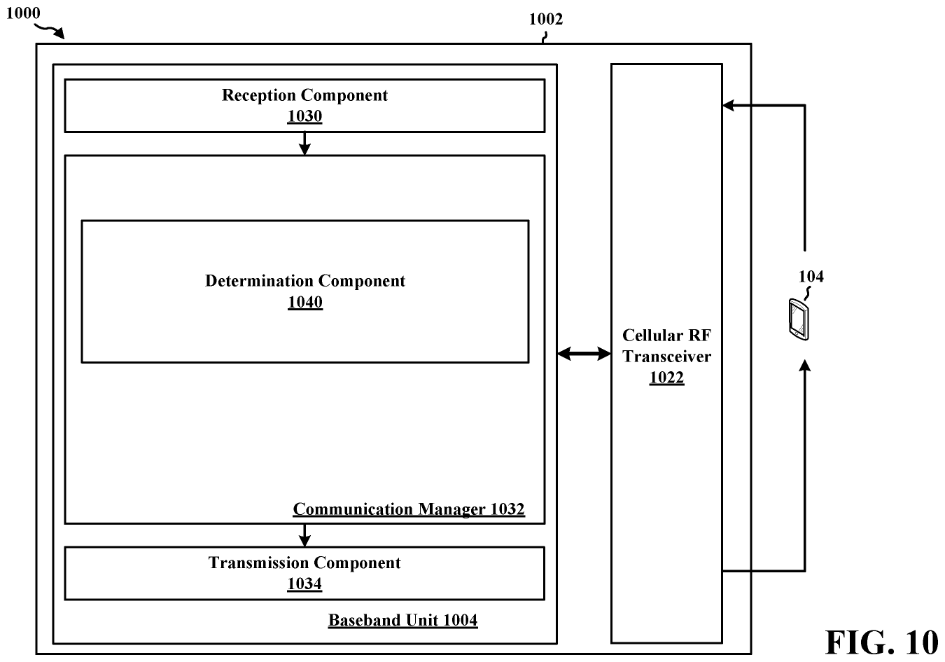

The controller/processor 359 can be associated with a memory 360 that stores program codes and data. The memory 360 may be referred to as a computer-readable medium which may store computer executable code for wireless communication of a user equipment (UE), the code when executed by a processor (e.g., one or more of RX processor 356, TX processor 368, and/or controller/processor 359) instructs the processor to perform aspects of FIGS. 9, 10, and/or 11. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium which may store computer executable code for wireless communication of base station, the code when executed by a processor (e.g., one or more of RX processor 370, TX processor 316, and/or controller/processor 375) instructs the processor to perform aspects of FIGS. 9, 10, and/or 11. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

In some aspects of wireless communications, e.g., 5G new radio (NR), a UE may be configured by a base station for a discontinuous reception (DRX) mode. In some instances, when there is no data to be transmitted between the UE and base station in either direction, e.g., no uplink or downlink transmissions, the UE may be configured with DRX mode in which the UE may monitor a control channel discontinuously using a sleep and awake cycle. Moreover, the DRX mode may conserve battery power at the UE. Without DRX, the UE may need to monitor the control channel in each subframe in order to determine whether there is data for the UE. Continuous monitoring of the control channel may place a demand on the UE's battery power.

A UE and a base station may communicate during a reception cycle. In some aspects, this may occur when the UE is configured by the base station for a DRX mode. Accordingly, the reception cycle may be a DRX cycle. In some aspects, a DRX cycle may be a reception cycle during which the UE and a base station communicate while the UE is in a DRX mode. Also, the UE may receive a configuration for the reception cycle from the base station. Before each DRX period, the base station may send a wake-up signal (WUS) or WUS monitoring occasion (MO).

In some instances, the base station may send a WUS to the UE when the base station will communicate data with the UE in the next DRX cycle. Accordingly, the base station may send a WUS with a WUS indication to the UE during the reception cycle. The WUS may be considered a type of DCI message. Further, a WUS indicator may be one bit in the WUS. When a WUS is received, a UE may go to sleep or stay awake, depending on the type of WUS indicator. In some aspects, during the reception cycle, the UE may determine whether to monitor for a WUS during WUS monitoring occasions. If the UE receives a WUS, the UE may wake-up by preparing to receive the communication. If the UE does not receive a WUS, the UE may skip the next DRX period and return to sleep mode.

In some modes of operation, a UE may be constantly awake and monitor for a PDCCH in each subframe. This means that the UE may be awake all of the time since the UE may not know exactly when the network will transmit data. By monitoring the PDCCH, the UE may monitor instructions from the network or base station. However, this PDCCH monitoring may consume a lot of power on the UE side. As mentioned above, DRX is a mechanism in which a UE transitions to sleep mode for a certain period of time and wakes-up for another period of time. One purpose of DRX may be to save power at the UE, such as by monitoring for a wake-up signal (WUS), which may reduce the amount of power utilized by the UE. So the DRX cycle may help to reduce power utilized at the UE by not continuously monitoring for the PDCCH. During a DRX cycle there may be multiple UE settings, such as an ‘ON’ time, i.e., where the UE monitors for the PDCCH, and an ‘OFF’ time, i.e., where the UE is not monitoring for the PDCCH and saving power.

There are a number of different parameters associated with DRX. As indicated above, the DRX cycle is the duration of one ON time and one OFF time. In some instances, the DRX cycle may be calculated by the subframe time and a longdrx-CycleStartOffset parameter. Also, the DRX cycle may not be explicitly specified in RRC messages. The onDurationTimer may be the duration of the ON time within one DRX cycle, e.g., the amount of time the UE monitors for the PDCCH. The drx-Inactivity timer may specify the amount of time the UE may remain ON after the reception of a PDCCH. When the drx-Inactivity timer is on, the UE may remain in an ON state which may extend the UE ON period into the period which is otherwise an OFF period. The drx-Retransmission timer may specify the maximum number of consecutive PDCCH subframes that the UE may remain active to wait for an incoming retransmission after the first available retransmission time. The shortDRX-Cycle may be a DRX cycle that may be implemented within the OFF period of a long DRX cycle. Also, the drxShortCycleTimer may be the consecutive number of subframes that the UE follows the short DRX cycle after the DRX inactivity timer has expired.

As indicated herein, aspects of DRX may include a WUS, which may help to notify the UE to wake-up for an ON period or PDCCH monitoring. So the WUS is a signal for which the UE monitors ahead of the ON duration. The UE may monitor for the WUS on less channels and/or utilize less power compared to normal PDCCH monitoring. Accordingly, a WUS may help the UE save power by reducing the need to fully monitor for the PDCCH. In some instances, a WUS may indicate for the UE to skip a monitoring cycle, as well as to follow a normal monitoring pattern. A WUS may also be associated with a DCI payload, which may include at least one wake-up indication bit. Also, a WUS may be shared by multiple UEs.

A number of different parameters may be provided for monitoring for a DCI including a DCI format, e.g., DCI format 2_6. For example, a radio network temporary identifier (RNTI) may be utilized for scrambling a cyclic redundancy check (CRC) of a DCI format, e.g., DCI format 2_6. In some instances, a type3-PDCCH common search space (CSS) set may be used for monitoring the DCI format, e.g., DCI format 2_6, with PS-RNTI. Also, more than one search space set may be configured for a DCI format, e.g., DCI format 2_6. Associated CORESETs with the search space sets may have different TCI states, e.g., WUS beam sweeping in frequency range 2 (FR2). Moreover, the payload size of the DCI format, e.g., DCI format 2_6, and the location of the wake-up indication bit may be utilized for indicating a position of UE-specific fields. A PDCCH-WUS, e.g., for DCI format 2_6, may be shared by a group of UEs. Also, each UE in a group may be assigned with a UE-specific field in the DCI.

In some aspects, secondary cell (SCell) groups, e.g., up to five groups, may be utilized for dormancy behavior indication outside of an active time. Also, SCell groups for a dormancy behavior indication during an active time, e.g., by scheduling DCI, may be configured separately. A time offset (ps_Offset) may indicate a time that the UE starts to locate monitoring occasions for the DCI format, e.g., DCI format 2_6, prior to a slot where a DRX cycle starts. For example, ps_Offset∈{0.125 ms, 0.25 ms, 0.375 ms, . . . , 15 ms}.

Additionally, there may be multiple DRX groups, such as where activated serving base stations may be configured by RRC signalling in two groups. Each group of serving base stations, which may be referred to as a DRX group, may be configured by RRC signalling with its own set of parameters that controls its DRX operation, such as by configuring a number of parameters. Each DRX group may have its own parameters, some of which may be shared or common to other DRX groups. Also, there may be a number of different independent parameters or common parameters. These parameters may include a drx-onDurationTimer, i.e., the duration at the beginning of a DRX Cycle, as well as a drx-InactivityTimer, i.e., the duration after the PDCCH occasion in which a PDCCH indicates a new uplink or downlink transmission for the medium access control (MAC) entity.

Moreover, multiple DRX groups may share a number of parameters, such as drx-SlotOffset, i.e., the delay before starting the drx-onDurationTimer. The drx-RetransmissionTimerDL (per downlink HARQ process except for the broadcast process) may also be shared, i.e., the maximum duration until a downlink retransmission is received. Also, a drx-Re transmission Timer UL parameter (per uplink HARQ process) may also be shared, i.e., the maximum duration until a grant for an uplink retransmission is received. The shared parameters may also be drx-LongCycleStartOffset, i.e., the long DRX cycle, and drx-StartOffset which defines the subframe where the long and short DRX cycle begins. The drx-ShortCycle may correspond to the short DRX cycle, and the drx-ShortCycleTimer may correspond to the duration the UE may follow the short DRX cycle. Further, the drx-HARQ-RTT-TimerDL (per downlink HARQ process except for the broadcast process) may be shared, i.e., the minimum duration before a downlink assignment for HARQ retransmission is expected by the MAC entity. The drx-HARQ-RTT-TimerUL (per uplink HARQ process) may also be a shared parameter, i.e., the minimum duration before an uplink HARQ retransmission grant is expected by the MAC entity.

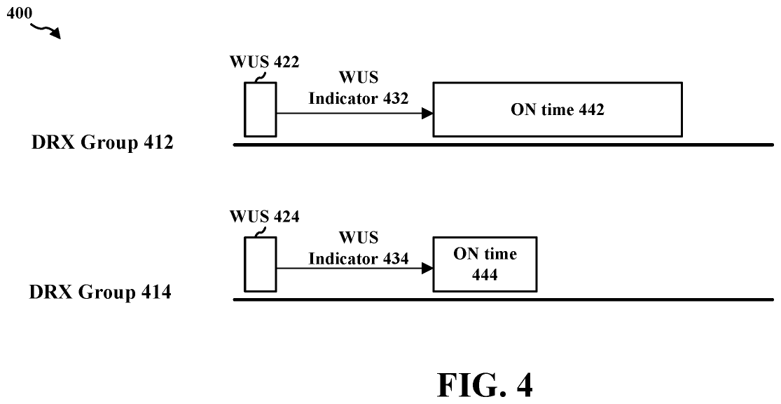

FIG. 4 is a diagram 400 illustrating example DRX communication. As shown in FIG. 4, diagram 400 includes DRX group 412 including ON time 442 and DRX group 414 including ON time 444. Diagram 400 also includes multiple WUSs, e.g., WUS 422 and WUS 424, as well as multiple WUS indicators, e.g., WUS indicator 432 and WUS indicator 434. FIG. 4 shows that aspects of wireless communication may include multiple DRX groups. The first DRX group, e.g., DRX group 412, may correspond to a first frequency range (FR1), e.g., 410-7125 MHz, and the second DRX group, e.g., DRX group 414, may correspond to a second frequency range (FR2), e.g., 24.25-52.6 GHz. The first DRX group and the second DRX group may correspond to any FR combination.

As further shown in FIG. 4, DRX group 412 may have an ON period of a different length compared to the ON period of DRX group 414. For example, ON time 442 is longer than ON time 444. For instance, DRX group 412 may be more power efficient compared to the DRX group 414, so DRX group 412 may be able to have a longer ON period. Also, WUS 422 may include a single WUS indicator 432 and WUS 424 may include a single WUS indicator 434.

There are a number of possible WUS designs for multiple DRX groups. For example, there may be one WUS per DRX group. Also, there may be one WUS for all DRX groups, e.g., one WUS with one WUS indicator for all DRX groups. However, using one WUS or one WUS indicator for each DRX group may limit the possibility of a UE receiving a WUS or WUS indicator for each DRX group. For instance, if the single WUS indicator is not successfully transmitted, all DRX groups may not receive a WUS indication. As such, it may be beneficial to transmit multiple WUSs or WUS indicators for each DRX group.

Aspects of the present disclosure may transmit multiple WUSs or WUS indicators for each DRX group. By doing so, aspects of the present disclosure may increase the reliability that a UE receives the correct WUS indicator for each DRX group. In the event one WUS indicator is not received, another of the multiple WUS indicators may act as a backup WUS indicator to be transmitted. So aspects of the present disclosure may include one WUS with two independent WUS indicators for each group. Based on this, there may be multiple WUSs received by one UE.

Utilizing multiple WUS indicators per WUS may include a number of benefits or advantages, such as improving the WUS diversity by simultaneously including two WUSs with two independent WUS indicators. These WUSs may be in a first DRX group and a second DRX group. For example, if a first WUS for the first DRX group collides with another RS, e.g., a SSB, the second WUS for the second DRX group in this design may provide a backup WUS indicator for the WUS indication for the group. Also, if one of the WUSs fails the CRC check, the other WUS may provide a backup for the system. So each WUS may include multiple WUS indicators for each DRX group, which may provide a backup WUS indicator for each DRX group, so that the likelihood of each DRX group receiving a WUS indicator is increased.

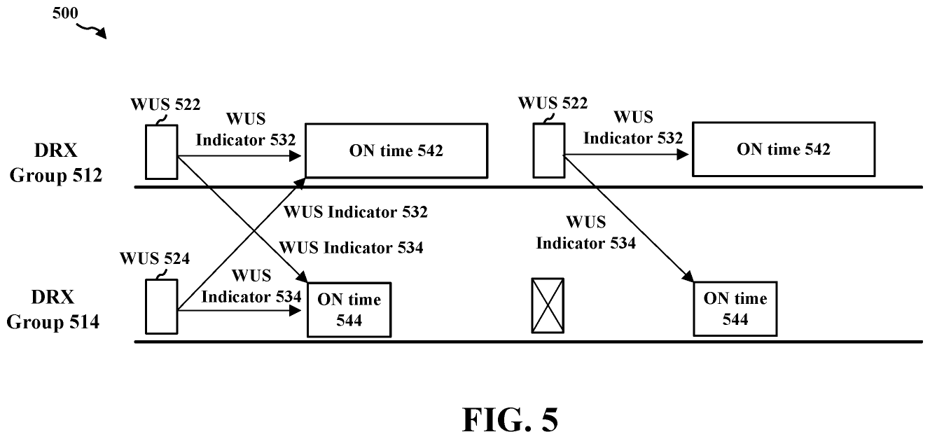

FIG. 5 is a diagram 500 illustrating example DRX communication in accordance with one or more techniques of the present disclosure. As shown in FIG. 5, diagram 500 includes DRX group 512 including ON time 542 and DRX group 514 including ON time 544. Diagram 500 also includes multiple WUSs, e.g., WUS 522 and WUS 524, Additionally, diagram 500 includes multiple WUS indicators, e.g., WUS indicator 532 and WUS indicator 534. Also, the first DRX group, e.g., DRX group 512, may correspond to a first frequency range (FR1), e.g., 410-7125 MHz, and the second DRX group, e.g., DRX group 514, may correspond to a second frequency range (FR2), e.g., 24.25-52.6 GHz.

FIG. 5 shows that each WUS may include multiple WUS indicators. For example, WUS 522 includes WUS indicator 532 and WUS indicator 534, and WUS 524 includes WUS indicator 532 and WUS indicator 534. As shown in FIG. 5, WUS indicator 532 may correspond to DRX group 512 and WUS indicator 534 may correspond to DRX group 514. As each WUS includes multiple WUS indicators, each DRX group may include multiple corresponding WUS indicators. Accordingly, each DRX group may include a backup WUS indicator. As shown in FIG. 5, WUS 524 is not received in the second DRX cycle, so DRX group 514 utilizes the WUS indicator 534 received from WUS 522.

As shown in FIG. 5, a first WUS, e.g., WUS 522, may correspond to a first DRX group or DRX group 512, and a second WUS, e.g., WUS 524, may correspond to a second DRX group or DRX group 514. As both WUS 512 and WUS 514 include two WUS indicators, e.g., WUS indicator 532 and WUS indicator 534, each of the DRX groups may receive multiple WUS indicators when both WUSs are successfully transmitted. By doing so, the present disclosure may increase the chance that a UE receives a WUS indicator for each DRX group. This improves the diversity of the WUS, such that if either WUS is lost or not transmitted, then each DRX group may still receive a WUS indicator from the other WUS.

As further shown in FIG. 5, DRX group 512 may have an ON period of a different length compared to the ON period of DRX group 514. For example, ON time 542 is longer than ON time 544. For instance, in some aspects, DRX group 512 may be more power efficient compared to DRX group 514, so DRX group 512 may be able to have a longer ON period.

In some aspects, if no WUS is detected, then the next DRX cycle may be controlled by an RRC flag, e.g., ps-WakeupOrNot. With multiple WUSs, there may be a change in specification if one WUS is lost or not transmitted, so a UE may not apply the RRC flag and seek another WUS indicator. A UE may also apply separate RRC flags for each DRX group. In some instances, if each WUS contains one wake-up indication bit in a DCI payload, then a UE may seek another WUS. Also, if no WUS is received, then a UE may use one RRC flag or separate RRC flags to control each DRX group.

In some instances, if a UE does not monitor a PDCCH for detection of a DCI format 2_6 (e.g., due to overlap with SSBs, other PDCCH occasions with different QCL-TypeD properties, a measurement gap, and/or a bandwidth part (BWP) switching delay) for each WUS monitor occasion (MO), then the UE may not be able to receive the WUS. For two WUSs, if one of the WUSs collides with the SSB or another RS, then the UE may follow the indications of another WUS, and may not wake-up. If each of the WUSs are not transmitted or received, then the UE may wake-up and/or follow the RRC flag(s). In some instances, there may be one RRC flag for multiple DRX groups. There may also be one RRC flag per DRX group. Also, the RRC flags may correspond to the WUS indicators, such that one RRC flag may be associated with multiple DRX groups, while another RRC flag may be associated with one DRX group.

If there are more than two DRX groups, e.g., three DRX groups, then each WUS may include a WUS indicator for each DRX group. So there may be a certain amount of DRX groups, e.g., N DRX groups, and each WUS may include a certain amount of WUS indicators, e.g., M WUS indicators, where M is less than or equal to N. Also, if the amount of WUS indicators is less than the amount of DRX groups, then some of the DRX groups may share the same WUS indicator. In some aspects, multiple DRX groups may share DCI. For example, in the DCI, the WUS indicator field may be a number of bits, e.g., one or two bits, and the content field may be another number of bits, e.g., four or five bits. There may also be a CRC field in the DCI.

Aspects of the present disclosure may also include a number of different components for WUS indication. As indicated herein, if both WUSs fail the CRC and/or no WUS is received, the UE may use an RRC flag to define the wake-up behavior. For instance, there may be one RRC flag for multiple DRX groups, or one RRC flag per DRX group. If the UE receives and decodes one WUS while another WUS fails the CRC check and/or is not transmitted, the UE may follow the WUS indications from the received WUS.

In another aspect, if two WUSs deliver conflicting WUS indications for certain DRX groups, e.g., WUS indicator 532 may inform the UE to wake-up for the next DRX cycle, while WUS indicator 534 may inform the UE to skip the next DRX cycle, then the UE may have several options. For example, the UE may follow the indication of the first-received WUS or the last-received WUS. Also, the DRX group with the conflicting indications may follow the WUS indication delivered to the group, i.e., the UE may ignore cross group indication. Further, the UE may follow an RRC field used to indicate which WUS has a higher priority, e.g., based on link quality. For example, if WUS 522 has a higher link quality than WUS 524, then the UE may follow the RRC field of WUS 522.

Additionally, if there are conflicting WUS indicators, the UE may stay awake or skip the next DRX cycle depending on the RRC flag, which may define a default behavior for conflicting WUS indicators. The UE may also follow the WUS with a highest reliability, e.g., the WUS with the fewest DCI payload bits. For instance, with a fixed CRC size in the DCI for the WUS, the reduced payload may provide an improved reliability. For example, the WUS indication bits and the content field bits in the DCI may be adjustable, but the CRC field may be fixed. Moreover, the UE may perform the operation of one or both of the conflicting WUS indicators, e.g., via RRC flag(s), such as by performing the first WUS indicator and/or the second WUS indicator.

As indicated above, the multiple DRX groups may correspond to each of multiple frequency ranges (FRs). So the operation of one UE may be associated with multiple DRX groups and/or multiple FRs. Also, the UE may receive multiple DRX configurations from a base station or a network.

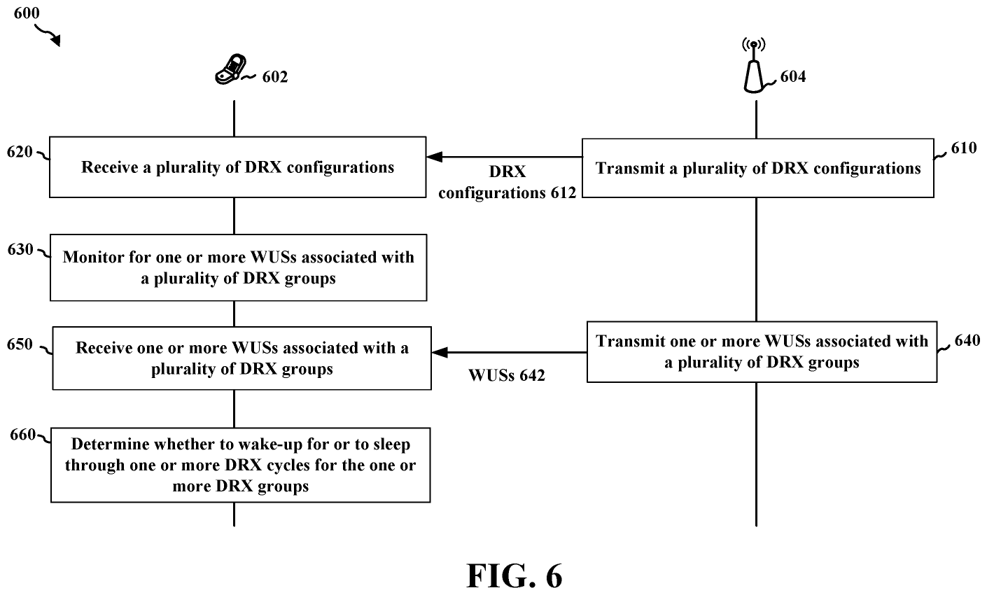

FIG. 6 is a diagram 600 illustrating example communication between a UE 602 and a TRP or base station 604. At 610, TRP 604 may transmit a plurality of discontinuous reception (DRX) configurations, e.g., DRX configurations 612, associated with a plurality of DRX groups.

At 620, UE 602 may receive a plurality of DRX configurations, e.g., DRX configurations 612, associated with a plurality of DRX groups.

At 630, UE 602 may monitor for one or more wake-up signals (WUSs) associated with the plurality of DRX groups based on the plurality of DRX configurations, at least one WUS of the one or more WUSs including one or more WUS indicators for the plurality of DRX groups.

At 640, TRP 604 may transmit one or more WUSs, e.g., WUSs 642, associated with the plurality of DRX groups based on the plurality of DRX configurations, at least one WUS of the one or more WUSs including one or more WUS indicators for the plurality of DRX groups. The at least one WUS indicator and the one or more WUS indicators may be associated with one or more DRX cycles for the plurality of DRX groups.

At 650, UE 602 may receive one or more WUSs, e.g., WUSs 642, including the at least one WUS, where the at least one WUS may be associated with at least two DRX groups of the plurality of DRX groups. In some aspects, the one or more WUS indicators of the at least one WUS may include a first WUS indicator and a second WUS indicator, the first WUS indicator may be associated with a first DRX group of the plurality of DRX groups and the second WUS indicator may be associated with a second DRX group of the plurality of DRX groups.

In some instances, each of the one or more WUSs may include one or more WUS indicators for the plurality of DRX groups, such that each of the one or more WUS indicators corresponds to one of the plurality of DRX groups. The determination whether to wake-up for or to sleep through the one or more DRX cycles for the plurality of DRX groups may be based on a first WUS indicator in a first-received WUS of the one or more WUSs or a last WUS indicator in a last-received WUS of the one or more WUSs. Also, the determination whether to wake-up for or to sleep through the one or more DRX cycles for the plurality of DRX groups may be based on the WUS associated with each of the plurality of DRX groups. In some instances, the determination whether to wake-up for or to sleep through the one or more DRX cycles for the plurality of DRX groups may be based on at least one radio resource control (RRC) field, where the RRC field may indicate a highest priority WUS of the one or more WUSs. The determination whether to wake-up for or to sleep through the one or more DRX cycles for the plurality of DRX groups may be based on at least one radio resource control (RRC) flag. Moreover, the determination whether to wake-up for or to sleep through the one or more DRX cycles for the plurality of DRX groups may be based on a WUS with a least amount of payload bits in DCI including a DCI format.

At 660, UE 602 may determine whether to wake-up for or to sleep through one or more DRX cycles for the plurality of DRX groups based on the at least one WUS indicator or the one or more WUS indicators.

In some aspects, the one or more WUS indicators of the at least one WUS may correspond to one or more wake-up indication bits in DCI including a DCI format. Also, each of the one or more DRX cycles may be associated with a wake-up or ON state and a sleep or OFF state. Further, each of the plurality of DRX configurations may be associated with each of one or more frequency ranges (FRs). The plurality of DRX groups may include a first DRX group and a second DRX group, where the first DRX group may be associated with a first DRX configuration of the plurality of DRX configurations and the second DRX group may be associated with a second DRX configuration of the plurality of DRX configurations.

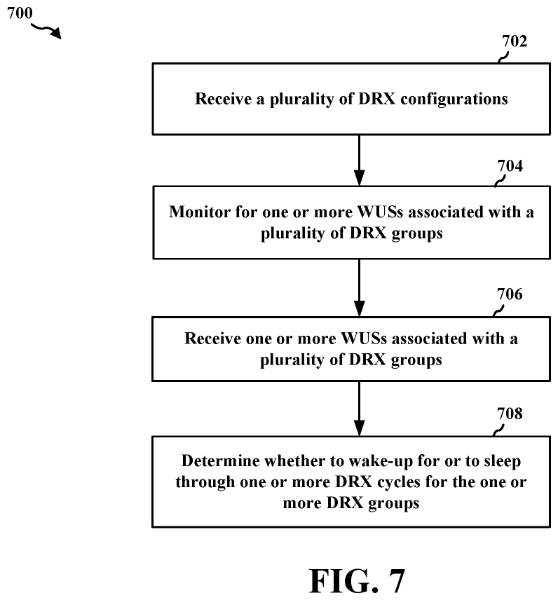

FIG. 7 is a flowchart 700 of a method of wireless communication. The method may be performed by a UE or a component of a UE (e.g., the UE 104, 350, 602; apparatus 902; a processing system, which may include the memory 360 and which may be the entire UE or a component of the UE, such as the TX processor 368, the controller/processor 359, transmitter 354TX antenna(s) 352, and/or the like). The methods described herein may provide a number of benefits, such as improving communication signaling, resource utilisation, and/or power savings.

At 702, the apparatus may receive a plurality of DRX configurations associated with a plurality of DRX groups, as described in connection with the examples in FIGS. 4, 5, and 6. For example, UE 602 may receive a plurality of DRX configurations associated with a plurality of DRX groups, as described in connection with 620 in FIG. 6. Further, 702 may be performed by determination component 940 in FIG. 9.

At 704, the apparatus may monitor for one or more wake-up signals (WUSs) associated with the plurality of DRX groups based on the plurality of DRX configurations, at least one WUS of the one or more WUSs including one or more WUS indicators for the plurality of DRX groups, as described in connection with the examples in FIGS. 4, 5, and 6. For example, UE 602 may monitor for one or more wake-up signals (WUSs) associated with the plurality of DRX groups based on the plurality of DRX configurations, at least one WUS of the one or more WUSs including one or more WUS indicators for the plurality of DRX groups, as described in connection with 630 in FIG. 6. Further, 704 may be performed by determination component 940 in FIG. 9.

At 706, the apparatus may receive one or more WUSs including the at least one WUS, where the at least one WUS may be associated with at least two DRX groups of the plurality of DRX groups, as described in connection with the examples in FIGS. 4, 5, and 6. For example, UE 602 may receive one or more WUSs including the at least one WUS, where the at least one WUS may be associated with at least two DRX groups of the plurality of DRX groups, as described in connection with 650 in FIG. 6. Further, 706 may be performed by determination component 940 in FIG. 9. In some aspects, the one or more WUS indicators of the at least one WUS may include a first WUS indicator and a second WUS indicator, the first WUS indicator may be associated with a first DRX group of the plurality of DRX groups and the second WUS indicator may be associated with a second DRX group of the plurality of DRX groups, as described in connection with the examples in FIGS. 4, 5, and 6.

In some instances, each of the one or more WUSs may include one or more WUS indicators for the plurality of DRX groups, such that each of the one or more WUS indicators corresponds to one of the plurality of DRX groups, as described in connection with the examples in FIGS. 4, 5, and 6. The determination whether to wake-up for or to sleep through the one or more DRX cycles for the plurality of DRX groups may be based on a first WUS indicator in a first-received WUS of the one or more WUSs or a last WUS indicator in a last-received WUS of the one or more WUSs, as described in connection with the examples in FIGS. 4, 5, and 6. Also, the determination whether to wake-up for or to sleep through the one or more DRX cycles for the plurality of DRX groups may be based on the WUS associated with each of the plurality of DRX groups, as described in connection with the examples in FIGS. 4, 5, and 6. In some instances, the determination whether to wake-up for or to sleep through the one or more DRX cycles for the plurality of DRX groups may be based on at least one radio resource control (RRC) field, where the RRC field may indicate a highest priority WUS of the one or more WUSs, as described in connection with the examples in FIGS. 4, 5, and 6. The determination whether to wake-up for or to sleep through the one or more DRX cycles for the plurality of DRX groups may be based on at least one radio resource control (RRC) flag, as described in connection with the examples in FIGS. 4, 5, and 6. Moreover, the determination whether to wake-up for or to sleep through the one or more DRX cycles for the plurality of DRX groups may be based on a WUS with a least amount of payload bits in DCI including a DCI format, as described in connection with the examples in FIGS. 4, 5, and 6.

At 708, the apparatus may determine whether to wake-up for or to sleep through one or more DRX cycles for the plurality of DRX groups based on the at least one WUS indicator or the one or more WUS indicators, as described in connection with the examples in FIGS. 4, 5, and 6. For example, UE 602 may determine whether to wake-up for or to sleep through one or more DRX cycles for the plurality of DRX groups based on the at least one WUS indicator or the one or more WUS indicators, as described in connection with 660 in FIG. 6. Further, 708 may be performed by determination component 940 in FIG. 9.

In some aspects, the one or more WUS indicators of the at least one WUS may correspond to one or more wake-up indication bits in DCI including a DCI format, as described in connection with the examples in FIGS. 4, 5, and 6. Also, each of the one or more DRX cycles may be associated with a wake-up or ON state and a sleep or OFF state, as described in connection with the examples in FIGS. 4, 5, and 6. Further, each of the plurality of DRX configurations may be associated with each of one or more frequency ranges (FRs), as described in connection with the examples in FIGS. 4, 5, and 6. The plurality of DRX groups may include a first DRX group and a second DRX group, where the first DRX group may be associated with a first DRX configuration of the plurality of DRX configurations and the second DRX group may be associated with a second DRX configuration of the plurality of DRX configurations, as described in connection with the examples in FIGS. 4, 5, and 6.

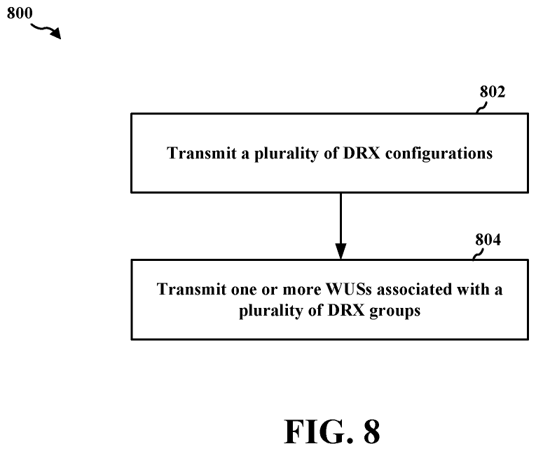

FIG. 8 is a flowchart 800 of a method of wireless communication. The method may be performed by a TRP or a base station or a component of a TRP or a base station (e.g., the base station 102, 180, 310, 604; apparatus 1002; a processing system, which may include the memory 376 and which may be the entire base station or a component of the base station, such as the antenna(s) 320, receiver 318RX, the RX processor 370, the controller/processor 375, and/or the like). The methods described herein may provide a number of benefits, such as improving communication signaling, resource utilisation, and/or power savings.

At 802, the apparatus may transmit a plurality of discontinuous reception (DRX) configurations associated with a plurality of DRX groups, as described in connection with the examples in FIGS. 4, 5, and 6. For example, TRP 604 may transmit a plurality of discontinuous reception (DRX) configurations associated with a plurality of DRX groups, as described in connection with 610 in FIG. 6. Further, 802 may be performed by determination component 1040 in FIG. 10.

At 804, the apparatus may transmit one or more WUSs associated with the plurality of DRX groups based on the plurality of DRX configurations, at least one WUS of the one or more WUSs including one or more WUS indicators for the plurality of DRX groups, as described in connection with the examples in FIGS. 4, 5, and 6. For example, TRP 604 may transmit one or more WUSs associated with the plurality of DRX groups based on the plurality of DRX configurations, at least one WUS of the one or more WUSs including one or more WUS indicators for the plurality of DRX groups, as described in connection with 640 in FIG. 6. Further, 804 may be performed by determination component 1040 in FIG. 10. The at least one WUS indicator and the one or more WUS indicators may be associated with one or more DRX cycles for the plurality of DRX groups, as described in connection with the examples in FIGS. 4, 5, and 6.

In some aspects, the at least one WUS may be associated with at least two DRX groups of the plurality of DRX groups, as described in connection with the examples in FIGS. 4, 5, and 6. Also, the one or more WUS indicators of the at least one WUS may include a first WUS indicator and a second WUS indicator, the first WUS indicator may be associated with a first DRX group of the plurality of DRX groups and the second WUS indicator may be associated with a second DRX group of the plurality of DRX groups, as described in connection with the examples in FIGS. 4, 5, and 6.

In some instances, each of the one or more WUSs may include one or more WUS indicators for the plurality of DRX groups, such that each of the one or more WUS indicators corresponds to one of the plurality of DRX groups, as described in connection with the examples in FIGS. 4, 5, and 6. The one or more DRX cycles for the plurality of DRX groups may be based on a first WUS indicator in a first-transmitted WUS of the one or more WUSs or a last WUS indicator in a last-transmitted WUS of the one or more WUSs, as described in connection with the examples in FIGS. 4, 5, and 6. Also, the one or more DRX cycles for the plurality of DRX groups may be based on the WUS associated with each of the plurality of DRX groups, as described in connection with the examples in FIGS. 4, 5, and 6. The one or more DRX cycles for the plurality of DRX groups may be based on at least one radio resource control (RRC) field, where the RRC field may indicate a highest priority WUS of the one or more WUSs, as described in connection with the examples in FIGS. 4, 5, and 6. Further, the one or more DRX cycles for the plurality of DRX groups may be based on at least one radio resource control (RRC) flag, as described in connection with the examples in FIGS. 4, 5, and 6. The one or more DRX cycles for the plurality of DRX groups may be based on a WUS with a least amount of payload bits in DCI including a DCI format, as described in connection with the examples in FIGS. 4, 5, and 6.

In some aspects, the one or more WUS indicators of the at least one WUS may correspond to one or more wake-up indication bits in DCI including a DCI format, as described in connection with the examples in FIGS. 4, 5, and 6. Also, each of the one or more DRX cycles may be associated with a wake-up or ON state and a sleep or OFF state, as described in connection with the examples in FIGS. 4, 5, and 6. Each of the plurality of DRX configurations may be associated with each of one or more frequency ranges (FRs), as described in connection with the examples in FIGS. 4, 5, and 6. Additionally, the plurality of DRX groups may include a first DRX group and a second DRX group, where the first DRX group may be associated with a first DRX configuration of the plurality of DRX configurations and the second DRX group may be associated with a second DRX configuration of the plurality of DRX configurations, as described in connection with the examples in FIGS. 4, 5, and 6.

FIG. 9 is a diagram 900 illustrating an example of a hardware implementation for an apparatus 902. The apparatus 902 is a UE and includes a cellular baseband processor 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see 350 of FIG. 3) and include the aforediscussed additional modules of the apparatus 902.

The communication manager 932 includes a determination component 940 that is configured to receive a plurality of discontinuous reception (DRX) configurations associated with a plurality of DRX groups, e.g., as described in connection with step 702 in FIG. 7. Determination component 940 may be further configured to monitor for one or more wake-up signals (WUSs) associated with the plurality of DRX groups based on the plurality of DRX configurations, at least one WUS of the one or more WUSs including one or more WUS indicators for the plurality of DRX groups, e.g., as described in connection with step 704 in FIG. 7. Determination component 940 may be further configured to receive the one or more WUSs including the at least one WUS, where the at least one WUS is associated with at least two DRX groups of the plurality of DRX groups, e.g., as described in connection with step 706 in FIG. 7. Determination component 940 may be further configured to determine whether to wake-up for or to sleep through one or more DRX cycles for the plurality of DRX groups based on the one or more WUS indicators of the at least one WUS, e.g., as described in connection with step 708 in FIG. 7.

The apparatus may include additional components that perform each of the blocks of the algorithm in the aforementioned flowcharts of FIGS. 6 and 7. As such, each block in the aforementioned flowcharts of FIGS. 6 and 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes means for receiving a plurality of discontinuous reception (DRX) configurations associated with a plurality of DRX groups; means for monitoring for one or more wake-up signals (WUSs) associated with the plurality of DRX groups based on the plurality of DRX configurations, at least one WUS of the one or more WUSs including one or more WUS indicators for the plurality of DRX groups; means for receiving the one or more WUSs including the at least one WUS, where the at least one WUS is associated with at least two DRX groups of the plurality of DRX groups; and means for determining whether to wake-up for or to sleep through one or more DRX cycles for the plurality of DRX groups based on the one or more WUS indicators of the at least one WUS. The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 10 is a diagram 1000 illustrating an example of a hardware implementation for an apparatus 1002. The apparatus 1002 is a base station (BS) or a TRP and includes a baseband unit 1004. The baseband unit 1004 may communicate through a cellular RF transceiver 1022 with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 310 and may include the memory 376 and/or at least one of the TX processor 316, the RX processor 370, and the controller/processor 375.

The communication manager 1032 includes a determination component 1040 that is configured to transmit a plurality of discontinuous reception (DRX) configurations associated with a plurality of DRX groups, e.g., as described in connection with step 802 in FIG. 8. Determination component 1040 may be further configured to transmit one or more wake-up signals (WUSs) associated with the plurality of DRX groups based on the plurality of DRX configurations, at least one WUS of the one or more WUSs including one or more WUS indicators for the plurality of DRX groups, e.g., as described in connection with step 804 in FIG. 8.

The apparatus may include additional components that perform each of the blocks of the algorithm in the aforementioned flowcharts of FIGS. 6 and 8. As such, each block in the aforementioned flowcharts of FIGS. 6 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes means for transmitting a plurality of discontinuous reception (DRX) configurations associated with a plurality of DRX groups; and means for transmitting one or more wake-up signals (WUSs) associated with the plurality of DRX groups based on the plurality of DRX configurations, at least one WUS of the one or more WUSs including one or more WUS indicators for the plurality of DRX groups. The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a user equipment (UE). The method includes receiving a plurality of discontinuous reception (DRX) configurations associated with a plurality of DRX groups; monitoring for one or more wake-up signals (WUSs) associated with the plurality of DRX groups based on the plurality of DRX configurations, at least one WUS of the one or more WUSs including one or more WUS indicators for the plurality of DRX groups; and determining whether to wake-up for or to sleep through one or more DRX cycles for the plurality of DRX groups based on the one or more WUS indicators of the at least one WUS.

Aspect 2 is the method of aspect 1, further including receiving the one or more WUSs including the at least one WUS, where the at least one WUS is associated with at least two DRX groups of the plurality of DRX groups.

Aspect 3 is the method of any of aspects 1 and 2, where the one or more WUS indicators of the at least one WUS include a first WUS indicator and a second WUS indicator, the first WUS indicator being associated with a first DRX group of the plurality of DRX groups and the second WUS indicator being associated with a second DRX group of the plurality of DRX groups.

Aspect 4 is the method of any of aspects 1 to 3, where each of the one or more WUSs includes one or more WUS indicators for the plurality of DRX groups, such that each of the one or more WUS indicators corresponds to one of the plurality of DRX groups.

Aspect 5 is the method of any of aspects 1 to 4, where the determination whether to wake-up for or to sleep through the one or more DRX cycles for the plurality of DRX groups is based on a first WUS indicator in a first-received WUS of the one or more WUSs or a last WUS indicator in a last-received WUS of the one or more WUSs.

Aspect 6 is the method of any of aspects 1 to 5, where the determination whether to wake-up for or to sleep through the one or more DRX cycles for the plurality of DRX groups is based on the WUS associated with each of the plurality of DRX groups.

Aspect 7 is the method of any of aspects 1 to 6, where the determination whether to wake-up for or to sleep through the one or more DRX cycles for the plurality of DRX groups is based on at least one radio resource control (RRC) field, where the RRC field indicates a highest priority WUS of the one or more WUSs.

Aspect 8 is the method of any of aspects 1 to 7, where the determination whether to wake-up for or to sleep through the one or more DRX cycles for the plurality of DRX groups is based on at least one radio resource control (RRC) flag.

Aspect 9 is the method of any of aspects 1 to 8, where the determination whether to wake-up for or to sleep through the one or more DRX cycles for the plurality of DRX groups is based on a WUS with a least amount of payload bits in downlink control information (DCI).

Aspect 10 is the method of any of aspects 1 to 9, where the one or more WUS indicators of the at least one WUS correspond to one or more wake-up indication bits in downlink control information (DCI).

Aspect 11 is the method of any of aspects 1 to 10, where each of the plurality of DRX configurations is associated with each of one or more frequency ranges (FRs).

Aspect 12 is the method of any of aspects 1 to 11, where the plurality of DRX groups include a first DRX group and a second DRX group, where the first DRX group is associated with a first DRX configuration of the plurality of DRX configurations and the second DRX group is associated with a second DRX configuration of the plurality of DRX configurations.

Aspect 13 is an apparatus for wireless communication including means for implementing a method as in any of aspects 1 to 12.

Aspect 14 is an apparatus for wireless communication including at least one processor coupled to a memory and configured to implement a method as in any of aspects 1 to 12.

Aspect 15 is a computer-readable medium storing computer executable code, where the code when executed by a processor causes the processor to implement a method as in any of aspects 1 to 12.

Aspect 16 is a method of wireless communication at a transmission-reception point (TRP). The method includes transmitting a plurality of discontinuous reception (DRX) configurations associated with a plurality of DRX groups; and transmitting one or more wake-up signals (WUSs) associated with the plurality of DRX groups based on the plurality of DRX configurations, at least one WUS of the one or more WUSs including one or more WUS indicators for the plurality of DRX groups; where the one or more WUS indicators of the at least one WUS are associated with one or more DRX cycles for the plurality of DRX groups.

Aspect 17 is the method of aspect 16, where the at least one WUS is associated with at least two DRX groups of the plurality of DRX groups.

Aspect 18 is the method of any of aspects 16 to 17, where the one or more WUS indicators of the at least one WUS include a first WUS indicator and a second WUS indicator, the first WUS indicator being associated with a first DRX group of the plurality of DRX groups and the second WUS indicator being associated with a second DRX group of the plurality of DRX groups.

Aspect 19 is the method of any of aspects 16 to 18, where each of the one or more WUSs includes one or more WUS indicators for the plurality of DRX groups, such that each of the one or more WUS indicators corresponds to one of the plurality of DRX groups.

Aspect 20 is the method of any of aspects 16 to 19, where the one or more DRX cycles for the plurality of DRX groups are based on a first WUS indicator in a first-transmitted WUS of the one or more WUSs or a last WUS indicator in a last-transmitted WUS of the one or more WUSs.

Aspect 21 is the method of any of aspects 16 to 20, where the one or more DRX cycles for the plurality of DRX groups are based on the WUS associated with each of the plurality of DRX groups.

Aspect 22 is the method of any of aspects 16 to 21, where the one or more DRX cycles for the plurality of DRX groups are based on at least one radio resource control (RRC) field, where the RRC field indicates a highest priority WUS of the one or more WUSs.

Aspect 23 is the method of any of aspects 16 to 22, where the one or more DRX cycles for the plurality of DRX groups are based on at least one radio resource control (RRC) flag.

Aspect 24 is the method of any of aspects 16 to 23, where the one or more DRX cycles for the plurality of DRX groups are based on a WUS with a least amount of payload bits in downlink control information (DCI).

Aspect 25 is the method of any of aspects 16 to 24, where the one or more WUS indicators of the at least one WUS correspond to one or more wake-up indication bits in downlink control information (DCI).

Aspect 26 is the method of any of aspects 16 to 25, where each of the plurality of DRX configurations is associated with each of one or more frequency ranges (FRs).

Aspect 27 is the method of any of aspects 16 to 26, where the plurality of DRX groups includes a first DRX group and a second DRX group, where the first DRX group is associated with a first DRX configuration of the plurality of DRX configurations and the second DRX group is associated with a second DRX configuration of the plurality of DRX configurations.

Aspect 28 is an apparatus for wireless communication including means for implementing a method as in any of aspects 16 to 27.

Aspect 29 is an apparatus for wireless communication including at least one processor coupled to a memory and configured to implement a method as in any of aspects 16 to 27.

Aspect 30 is a computer-readable medium storing computer executable code, where the code when executed by a processor causes the processor to implement a method as in any of aspects 16 to 27.

What is claimed is:

1. An apparatus for wireless communication at a user equipment (UE), comprising:
a memory; and
at least one processor coupled to the memory and configured to:
receive a plurality of discontinuous reception (DRX) configurations associated with a plurality of DRX groups;
monitor for one or more wake-up signals (WUSs) associated with the plurality of DRX groups based on the plurality of DRX configurations, at least one WUS of the one or more WUSs including one or more WUS indicators for the plurality of DRX groups; and
determine whether to wake-up for or to sleep through one or more DRX cycles for the plurality of DRX groups based on the one or more WUS indicators of the at least one WUS.

2. The apparatus of claim 1, wherein the at least one processor is further configured to:
receive the one or more WUSs including the at least one WUS, wherein the at least one WUS is associated with at least two DRX groups of the plurality of DRX groups.

3. The apparatus of claim 2, wherein the one or more WUS indicators of the at least one WUS include a first WUS indicator and a second WUS indicator, the first WUS indicator being associated with a first DRX group of the plurality of DRX groups and the second WUS indicator being associated with a second DRX group of the plurality of DRX groups.

4. The apparatus of claim 2, wherein each of the one or more WUSs includes one or more WUS indicators for the plurality of DRX groups, such that each of the one or more WUS indicators corresponds to one of the plurality of DRX groups.

5. The apparatus of claim 4, wherein the determination whether to wake-up for or to sleep through the one or more DRX cycles for the plurality of DRX groups is based on a first WUS indicator in a first-received WUS of the one or more WUSs or a last WUS indicator in a last-received WUS of the one or more WUSs.

6. The apparatus of claim 4, wherein the determination whether to wake-up for or to sleep through the one or more DRX cycles for the plurality of DRX groups is based on the WUS associated with each of the plurality of DRX groups.

7. The apparatus of claim 4, wherein the determination whether to wake-up for or to sleep through the one or more DRX cycles for the plurality of DRX groups is based on at least one radio resource control (RRC) field, wherein the RRC field indicates a highest priority WUS of the one or more WUSs.

8. The apparatus of claim 4, wherein the determination whether to wake-up for or to sleep through the one or more DRX cycles for the plurality of DRX groups is based on at least one radio resource control (RRC) flag.

9. The apparatus of claim 4, wherein the determination whether to wake-up for or to sleep through the one or more DRX cycles for the plurality of DRX groups is based on a WUS with a least amount of payload bits in downlink control information (DCI).

10. The apparatus of claim 1, wherein the one or more WUS indicators of the at least one WUS correspond to one or more wake-up indication bits in downlink control information (DCI).

11. The apparatus of claim 1, wherein each of the plurality of DRX configurations is associated with each of one or more frequency ranges (FRs).

12. The apparatus of claim 1, wherein the plurality of DRX groups includes a first DRX group and a second DRX group, wherein the first DRX group is associated with a first DRX configuration of the plurality of DRX configurations and the second DRX group is associated with a second DRX configuration of the plurality of DRX configurations.

13. A method of wireless communication performed by a user equipment (UE), comprising:
receiving a plurality of discontinuous reception (DRX) configurations associated with a plurality of DRX groups;
monitoring for one or more wake-up signals (WUSs) associated with the plurality of DRX groups based on the plurality of DRX configurations, at least one WUS of the one or more WUSs including one or more WUS indicators for the plurality of DRX groups; and
determining whether to wake-up for or to sleep through one or more DRX cycles for the plurality of DRX groups based on the one or more WUS indicators of the at least one WUS.

14. The method of claim 13, further comprising:
receiving the one or more WUSs including the at least one WUS, wherein the at least one WUS is associated with at least two DRX groups of the plurality of DRX groups.

15. The method of claim 14, wherein the one or more WUS indicators of the at least one WUS include a first WUS indicator and a second WUS indicator, the first WUS indicator being associated with a first DRX group of the plurality of DRX groups and the second WUS indicator being associated with a second DRX group of the plurality of DRX groups.

16. The method of claim 14, wherein each of the one or more WUSs includes one or more WUS indicators for the plurality of DRX groups, such that each of the one or more WUS indicators corresponds to one of the plurality of DRX groups, wherein the determination whether to wake-up for or to sleep through the one or more DRX cycles for the plurality of DRX groups is based on a first WUS indicator in a first-received WUS of the one or more WUSs or a last WUS indicator in a last-received WUS of the one or more WUSs.

17. The method of claim 14, wherein each of the one or more WUSs include the one or more WUS indicators for the plurality of DRX groups, wherein the determination whether to wake-up for or to sleep through the one or more DRX cycles for the plurality of DRX groups is based on at least one radio resource control (RRC) field, wherein the RRC field indicates a highest priority WUS of the one or more WUSs.

18. An apparatus for wireless communication at a transmission-reception point (TRP), comprising:
a memory; and
at least one processor coupled to the memory and configured to:
transmit a plurality of discontinuous reception (DRX) configurations associated with a plurality of DRX groups; and
transmit one or more wake-up signals (WUSs) associated with the plurality of DRX groups based on the plurality of DRX configurations, at least one WUS of the one or more WUSs including one or more WUS indicators for the plurality of DRX groups;
wherein the one or more WUS indicators of the at least one WUS are associated with one or more DRX cycles for the plurality of DRX groups.

19. The apparatus of claim 18, wherein the at least one WUS is associated with at least two DRX groups of the plurality of DRX groups.

20. The apparatus of claim 19, wherein the one or more WUS indicators of the at least one WUS include a first WUS indicator and a second WUS indicator, the first WUS indicator being associated with a first DRX group of the plurality of DRX groups and the second WUS indicator being associated with a second DRX group of the plurality of DRX groups.

21. The apparatus of claim 19, wherein each of the one or more WUSs includes one or more WUS indicators for the plurality of DRX groups, such that each of the one or more WUS indicators corresponds to one of the plurality of DRX groups.

22. The apparatus of claim 21, wherein the one or more DRX cycles for the plurality of DRX groups are based on a first WUS indicator in a first-transmitted WUS of the one or more WUSs or a last WUS indicator in a last-transmitted WUS of the one or more WUSs.

23. The apparatus of claim 21, wherein the one or more DRX cycles for the plurality of DRX groups are based on the WUS associated with each of the plurality of DRX groups.

24. The apparatus of claim 21, wherein the one or more DRX cycles for the plurality of DRX groups are based on at least one radio resource control (RRC) field, wherein the RRC field indicates a highest priority WUS of the one or more WUSs.

25. The apparatus of claim 21, wherein the one or more DRX cycles for the plurality of DRX groups are based on at least one radio resource control (RRC) flag.

26. The apparatus of claim 21, wherein the one or more DRX cycles for the plurality of DRX groups are based on a WUS with a least amount of payload bits in downlink control information (DCI).

27. The apparatus of claim 18, wherein the one or more WUS indicators of the at least one WUS correspond to one or more wake-up indication bits in downlink control information (DCI).

28. The apparatus of claim 18, wherein each of the plurality of DRX configurations is associated with each of one or more frequency ranges (FRs).

29. The apparatus of claim 18, wherein the plurality of DRX groups includes a first DRX group and a second DRX group, wherein the first DRX group is associated with a first DRX configuration of the plurality of DRX configurations and the second DRX group is associated with a second DRX configuration of the plurality of DRX configurations.

30. A method of wireless communication performed by a transmission-reception point (TRP), comprising:
transmitting a plurality of discontinuous reception (DRX) configurations associated with a plurality of DRX groups; and
transmitting one or more wake-up signals (WUSs) associated with the plurality of DRX groups based on the plurality of DRX configurations, at least one WUS of the one or more WUSs including one or more WUS indicators for the plurality of DRX groups;
wherein the one or more WUS indicators of the at least one WUS are associated with one or more DRX cycles for the plurality of DRX groups.
